(19) United States
(12) Patent Application Publication
(10) Pub. No.: US 2018/0039943 A1
(43) Pub. Date: Feb. 8, 2018

(54) SYSTEMS AND METHODS FOR MATCHING BASED ON DATA COLLECTION

(71) Applicant: The Mentor Method, LLC, Alexandria, VA (US)

(72) Inventor: Janice Ekita Omadeke, Alexandria, VA (US)

(21) Appl. No.: 15/667,908

(22) Filed: Aug. 3, 2017

Related U.S. Application Data
(60) Provisional application No. 62/370,477, filed on Aug. 3, 2016.

(51) Int. Cl. G06Q 10/10; G06F 17/30; G06Q 10/06

(52) U.S. Cl. CPC G06Q 10/105; G06Q 10/06398; G06F 17/30029; G09B 19/00

(57) ABSTRACT

A system comprises a first client device, a second client device, a data store, one or more information sources communicatively coupled to a network, and a server communicatively coupled to the first client device, the second client device, the data store, and the network. The first client device can receive a first set of user input data from a first user and the second client device can receive a second set of user input data from a second user. The server can search the one or more information sources for first secondary information associated with the first set of user input data and for second secondary information associated with the second set of user input data. The server can apply a matching model based on the first set of user input data, the second set of user input data, the first secondary information, and the second secondary information.

### REFERENCE TO RELATED APPLICATIONS

This application claims the benefit of and priority to U.S. 62/370,477, filed on Aug. 3, 2016, entitled “Online service matching two parties interested in establishing a mentor/mentee relationship,” the entire contents of which are incorporated herein by reference.

### FIELD OF THE INVENTION

The invention relates generally to systems and methods for collecting information and applying matching models to match users. More particularly, in various aspects, the invention relates to matching users having a degree of relatedness.

### BACKGROUND

The ability to find, connect, and communicate with a mentor with the intentions of career advice, professional development, and networking is antiquated and complicated. Currently, in-office mentor matching does not allow mentees to select the mentor of their choice to build a career advisement relationship. Networking events, another popular source for finding and communicating with mentors, do not guarantee that those attending are interested in mentorship and people have no clear indication of whether or not there is a good match for them. However, there remains a long felt need to match two or more people to build a professional relationship by matching based on career aspirations and personality type.

### SUMMARY OF INVENTION

The present disclosure relates to a system comprising a first client device, a second client device, a data store, one or more information sources communicatively coupled to a network, and a server communicatively coupled to the first client device, the second client device, the data store, and the network. The first client device can receive a first set of user input data from a first user. The second client device can receive a second set of user input data from a second user. The data store can store the first set of user input data and the second set of user input data. The server can receive the first set of user input data from the first client device and the second set of user input data from the second client device. Based on the received first set of user input data, the server can search the one or more information sources for first secondary information associated with the first set of user input data. Based on the received second set of user input data, the server can search the one or more information sources for second secondary information associated with the second set of user input data. The server can store the received first set of user input data, the received second set of user input data, the first secondary information, and the second secondary information in the data store. The server can apply a matching model based on at least the received first set of user input data, the received second set of user input data, the first secondary information, and the second secondary information to determine a match between the first user and the second user. In response to determining the match between the first user and the second user, the server can transmit an indication to the first client device including information corresponding to the second user.

According to one implementation, the first user is a mentee and the second user is a mentor.

In some implementations, the first set of user input data can include responses to a first set of queries presented to the first user by the first client device. The second set of user input data can include responses to a second set of queries presented to the second user by the second client device.

In other implementations, the first client device can include a first user interface that can receive the first set of user input data. The second client device can include a second user interface that can receive the second set of user input data.

In certain implementations, the server can receive a first location indicator from the first client device. The server can receive a second location indicator from the second client device. In some implementations, the server receives a location indicator from the first client device and/or second client device. The server may receive the location indicator during a registration process of a client device with the server. The server may send a request to a client device from a location indicator and/or identifying information of the client device. The location indicator may include, without limitation, an IP address, global positioning system (GPS) data, mobile network location data, physical address data, a ZIP code, and/or location data, The identifying information may include a MAC address, a telephone number, an electronic serial number (ESN), and International Mobile Identification Number (IMSI), a user account name, password, digital signature, a computer serial number, and/or a unique identifier of the client device or user of the client device.

According to one implementation, the server can determine a first geographical location corresponding to the first location indicator. The server can determine a second geographical location corresponding to the second location indicator. The server can determine if the first geographical location is equivalent to the second geographical location. If the first geographical location is not equivalent to the second geographical location, the server can transmit the second geographical location to the first client device. Alternatively, if the first geographical location is the same as the second geographical location, the server may transmit an indication to the first client device that indicates that the second client device of the second user is at the same geographical location.

In some implementations, the first set of user input data can include the first location indicator. The second set of user input data can include the second location indicator.

In other implementations, the server can receive the first location indicator in response to sending a first query to the first client device. The server can receive the second location indicator in response to sending a second query to the second client device.

In certain implementations, the server can receive identifier information from at least one of the first client device and the second client device.

In some implementations, the matching model can include at least one of graph theory based algorithm, blossom algorithm, Hungarian matching algorithm, Hoperoft-Karp algorithm, Gale-Shaply algorithm, stable matching problem algorithm, Nash equilibrium algorithm, rainbow algorithm, Irving's algorithm, multi-criteria index matching algorithm, gradient boosted decision trees (GBDT) algorithm, and Match-pairing algorithms.

In other implementations, determining the match can include determining a degree of relatedness between the first user and the second user. Determining the match can include determining that the degree of relatedness is greater than or equal to a threshold limit.

A second aspect of the present disclosure relates to a method for matching users. The method comprises receiving a first set of user input data from a first user at a first client device. Further, the method comprises receiving a second set of user input data from a second user at a second client device. The method further comprises storing the first set of user input data and the second set of user input data at a data store. The method also comprises communicatively coupling a server to the first client device, the second client device, the data store, and a network, the network being communicatively coupled to one or more information sources. Further, the method comprises, receiving, at the server, the first set of user input data from the first client device and the second set of user input data from the second client device. The method further comprises, based on the received first set of user input data, searching, at the server, the one or more information sources for first secondary information associated with the first set of user input data. The method also comprises, based on the received second set of user input data, searching, at the server, the one or more information sources for second secondary information associated with the second set of user input data. Further, the method comprises, storing the received first secondary information and received second secondary information at the data store. The method further comprises applying a matching model, at the server, based on at least the received first set of user input data, the received second set of user input data, the first secondary information, and the second secondary information to determine a match between the first user and the second user. The method also comprises, in response to determining the match between the first user and the second user, transmitting, at the server, an indication to the first client device including information corresponding to the second user.

According to one implementation, the first set of user input data can include responses to a first set of queries presented to the first user by the first client device. The second set of user input data can include responses to a second set of queries presented to the second user by the second client device.

In some implementations, the method further comprises receiving a first location indicator from the first client device and receiving a second location indicator from the second client device. The method also comprises determining a first geographical location corresponding to the first location indicator and determining a second geographical location corresponding to the second location indicator. Further, the method comprises, in response to determining that the first geographical location is not equivalent to the second geographical location, transmitting the second geographical location to the first client device.

According to some implementations, the determining the match further comprises determining a degree of relatedness between the first and second user. In some implementations, determining the match further comprises determining that the degree of relatedness is greater than or equal to a threshold limit.

### BRIEF DESCRIPTION OF THE DRAWINGS

The foregoing and other objects and advantages will be apparent upon consideration of the following detailed description, taken in conjunction with the accompanying drawings, in which like reference characters refer to like parts throughout, and in which:

FIG. 1 shows a schematic representation of a matching system, configured according to one or more embodiments of the present disclosure;

FIG. 2 shows a schematic representation of a client device interfacing with a network, configured according to one or more embodiments of the present disclosure;

FIG. 3 shows a schematic representation of a server interfacing with information sources using a network, configured according to one or more embodiments of the present disclosure;

FIG. 4 is a flow diagram of method steps for matching a first user and a second user, according to an embodiment of the present disclosure;

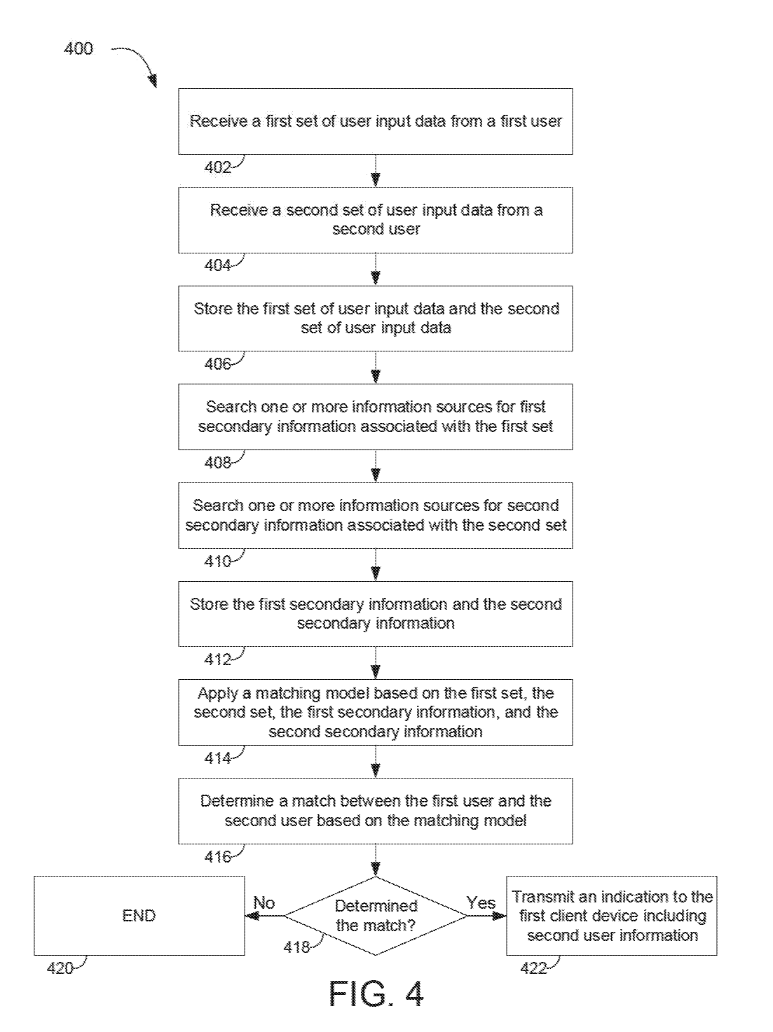

### DETAILED DESCRIPTION

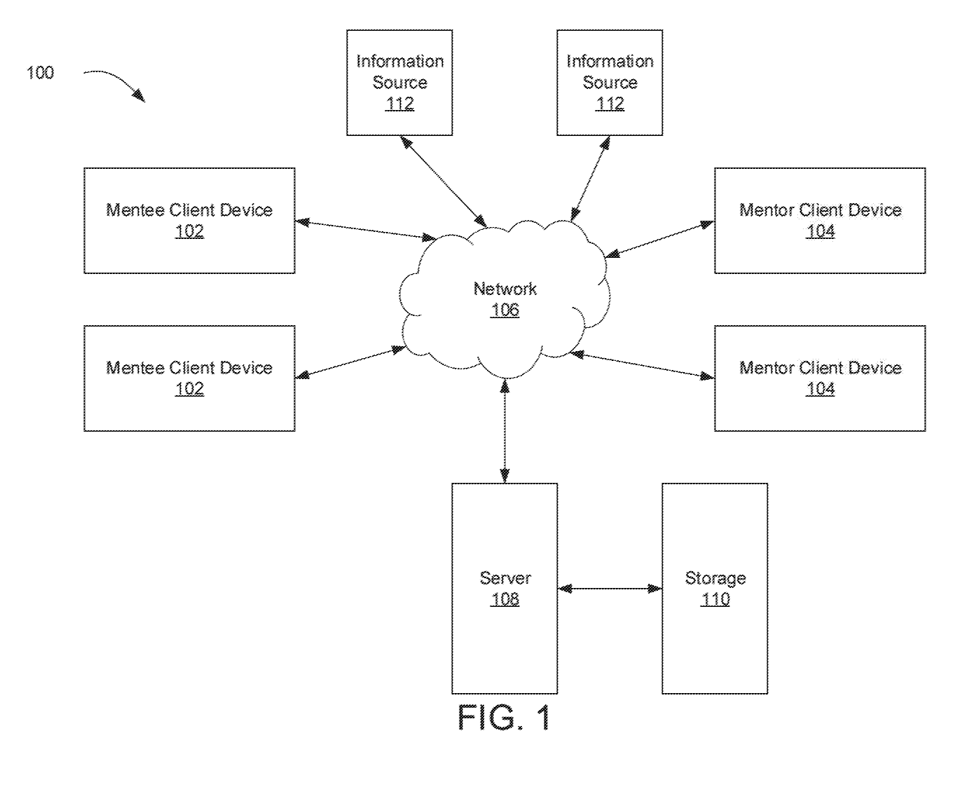

FIG. 1 shows a schematic representation of a matching system 100 comprising mentee client device 102, mentor client device 104, network 106, server 108, storage 110, and information source 112. Mentee client device 102 may be used by a user to provide input data in order to be matched with a mentor. Mentor client device 104 may be used by a user to provide input data in order to be matched with a mentee. Mentee client device 102 and mentor client device 104 are further described in the description of system 200. Matching system 100 may comprise one or more mentee client devices 102 as well as one or more mentor client devices 104.

Network 106 represents a network of internet-based devices and connections such as servers, storage, and applications. Server 108 may be the receiver of input data from mentee client device 102 and mentor client device 104, as well as data structures from information source 112. Server 108 may also transmit signals to mentee client device 102 and mentor client device 104. Storage 110 may be non-volatile storage that can maintain data for long periods of time and may comprise hard disks, optical disks, solid-state drives (SSDs), or another type of non-volatile memory. Information source 112 may be a database with accessible data structures that comprise information corresponding to a user. Information source 112 is further described in the description of system 300.

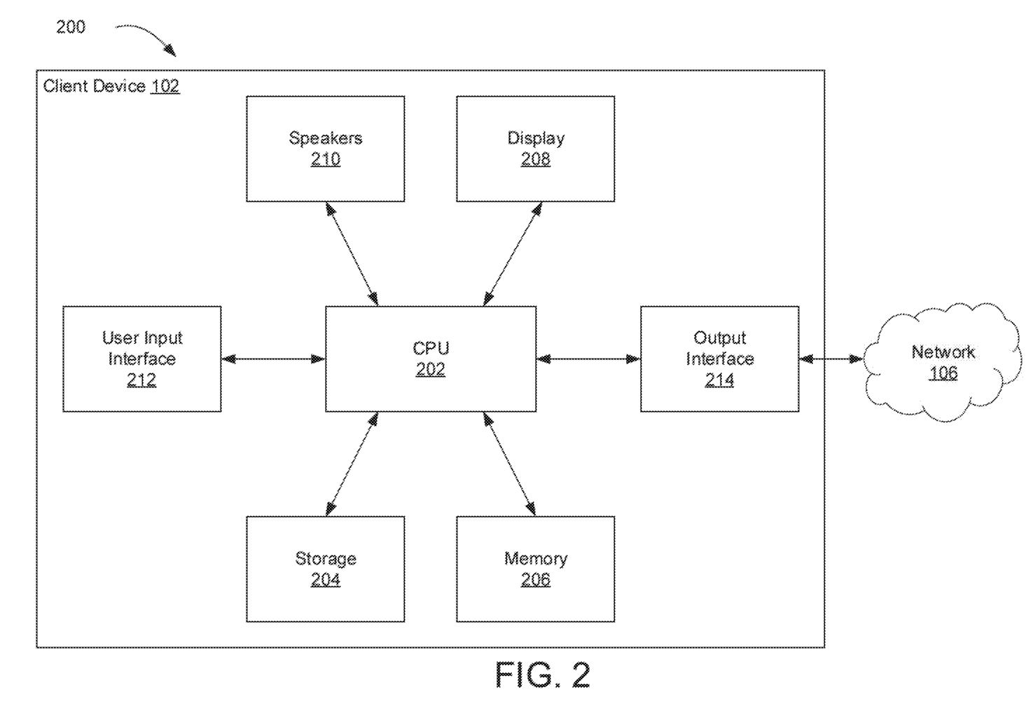

FIG. 2 shows a schematic representation of a system 200 comprising a client device 102 interfacing with network 106. Client device 102 comprises CPU (central processing unit) 202, storage 204, memory 206, display 208, speakers 210, user input interface 212, and output interface 214. CPU 202 may include a single microprocessor or multiple microprocessors. Storage 204 may be non-volatile storage that can maintain data for long period of time. Storage 204 may comprise hard disks, optical disks, SSDs, or another type of non-volatile memory. Memory 206 may be volatile storage that can be accessed quickly. Memory 206 may comprise dynamic random-access memory (DRAM), static random-access memory (SRAM), or another type of high-speed volatile memory.

Display 208 may be provided as a stand-alone device or integrated with client device 102 and may comprise one or more of a monitor, a television, a liquid crystal display (LCD) for a mobile device, or any other suitable equipment for displaying visual images. Speakers 208 may be any suitable equipment for playing audio. User input interface 212 may comprise a keyboard, a mouse, a touch screen display, or any other suitable equipment for user input. Output interface 214 may comprise any suitable data communication device that can interface with network 106. The network 106 may include the Internet, an intranet, private data network, wireless network, mobile data network, satellite network, and the like.

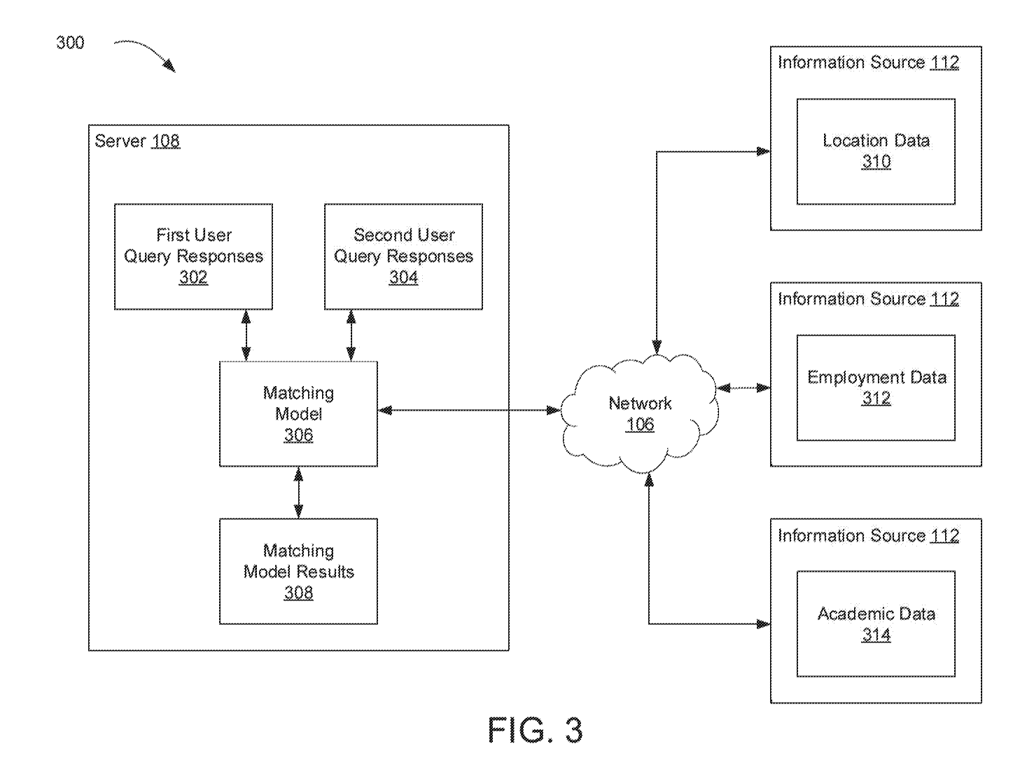

FIG. 3 shows a schematic representation of a system 300 comprising a server 108 interfacing with information sources 112 using network 106. Server 108 comprises first user query responses 302, second user query responses 304, matching model 306, and matching model results 308. System 300 includes multiple information sources 112 that can each include different type of data. The first information source 112 comprises location data 310. The second information source 112 comprises employment data 312. The third information source 112 comprises academic data 314.

First user query responses 302 may correspond to responses made by a user to queries presented on display 208 of mentee client device 102. The user may input the first user query responses 302 on user input interface 212 of mentee client device 102. Second user query responses 304 may correspond to responses made by a user to queries presented on display 208 of mentor client device 102. The user may input the second user query response 304 on user interface 212 of mentor client device 102.

Matching model 306 may correspond to any suitable model that can be used to match users based on similarities or differences in data structures representing characteristics of the users. Examples of models that can be implemented using matching model 306 include graph theory based algorithm, blossom algorithm, Hungarian matching algorithm, Hoperoft-Karp algorithm, Gale-Shaply algorithm, stable matching problem algorithm, Nash equilibrium algorithm, rainbow algorithm, Irving's algorithm, multi-criteria index matching algorithm, gradient boosted decision trees (GBDT) algorithm, and Match-pairing algorithm. Matching model 306 may use first user query responses 302 and second user query responses 304 as inputs to the model to determine a match.

Matching model 306 may also use secondary information from any information source 112. For example, in addition to first user query responses 302 and second user query responses 304, matching model 306 may use location data 310, employment data 312, and/or academic data 314 to further narrow the matching possibilities resulting from the matching model 306. Matching model results 308 may correspond to the resulting match or plurality of matches from the matching model 306. Secondary information may include user social media information, employment information, education information, personal information, relationship information, technical expertise, published articles, legal information, criminal history, and any information regarding a user being available via an information source. Server 108 may store the data in matching model results 308 into storage 110. Server 108 may include a web server. A client device 102 or 104 may include a web client such as, without limitation, Google Chrome, Internet Explorer, and the like.

A process 300 of method steps for matching a first user and a second user using matching system 100 is illustrated in FIG. 3. The process 300 begins by receiving a first set of user input data from a first user in step 402. For example, in matching system 100, mentee client device 102 may receive user input data from a first user. The first user may be a user that desires to be matched as a mentee in a mentorship relationship. The first user may input the user input data using user input interface 212. The user input data may include query responses to queries presented to the first user using display 208 and/or speakers 210. CPU 202 of mentee client device 102 may store the first set of user input data in storage 204 and may transmit the first set of user input data to server 108 using output interface 214.

Process 300 continues by receiving a second set of user input data from a second user in step 404. For example, in matching system 100, mentor client device 104 may receive user input data from a second user. The second user may be a user that desires to be matched as a mentor in a mentorship relationship. The second user may input the user input data using user input interface 212. The user input data may include query responses to queries presented to the second user using display 208 and/or speakers 210. CPU 202 of mentor client device 104 may store the second set of user input data in storage 204 and may transmit the second set of user input data to server 108 using output interface 214.

Process 300 continues by storing the first set of user input data and the second set of user input data in step 406. For example, in matching system 100, server 108 may receive the first set of user input data from output interface 212 of mentee client device 102 and the second set of user input data from output interface 212 of mentor client device 104. Server 108 may store the first set of user input data and the second set of user input data in storage 110.

Process 300 continues by searching one or more information sources for first secondary information associated with the first set in step 408. For example, in matching system 100, server 108 may search one or more information sources 112 for information associated with the first set of user input data of the first user. Information source 112 may include location data 310, employment data 312, academic data 314, or other data pertaining to a first user's characteristics, history, or personality.

Process 300 continues by searching one or more information sources for second secondary information associated with the second set in step 410. For example, in matching system 100, server 108 may search one or more information sources 112 for information associated with the second set of user input data of the second user. Information source 112 may include location data 310, employment data 312, academic data 314, or other data pertaining to a second user's characteristics, history, or personality.

Process 300 continues by storing the first secondary information and the second secondary information in step 412. For example, in matching system 100, server 108 may store the first secondary information associated with the first set of user input data and the second secondary information associated with the second set of user input data in storage 110.

Process 300 continues by applying a matching model based on the first set, the second set, the first secondary information, and the second secondary information in step 414. For example, in matching system 100, server 108 may implement matching model 306 using the first set of user input data and the second set of user input data. Server 108 may also implement matching model 306 with the first secondary information associated with the first set of user input data and the second secondary information associated with the second set of user input data. For example, in addition to first user query responses 302 and second user query responses 304, matching model 306 may use location data 310, employment data 312, and/or academic data 314 to further narrow the matching possibilities resulting from the matching model 306. In one implementation, the matching model may assign multiple categories of matching criteria to a user. A matching criteria may include, without limitation, sex, age range, ethnicity, education level, educational degrees, profession, experience range, publications, awards, and so on. A simple matching model may perform a pairwise comparison of information gathered for each matching category between the first user and the second user. The matching model may assign a binary “1” if a criterion is the same between the first user and the second user in a category. For example, the matching model assigns a “1” if both the first user and the second user are “female.” The matching model may then accumulate a total score based on counting the number of categories having the same criterion (value) between the first user and the second user. The higher the total score, the higher the degree of relatedness between the first user and the second user. For example, if 100 categories are compared between the first user and the second user (based on user input data and secondary data gather via searches), and the criterion (value) in 75 categories are the same, then the degree of relatedness may be 75% (e.g., 75 matching categories out of 100 categories). The matching model may be configured with a threshold value between 0%-100% to identify whether there is a sufficient degree of relatedness between the first user and the second user to establish a match between the first user and second user. If the threshold value is set at 80%, but the degree of relatedness is determined to be 75%, the matching model determines there is no match between the first user and the second user. If the threshold value is set at 75%, while the degree of relatedness is determined to be 75%, the matching model determines there is a match between the first user and the second user. While the foregoing is an example of a simplified matching model, one of ordinary skill would understand and be capable of implementing various other less or more sophisticated matching models.

Process 300 continues by determining a match between the first user and the second user based on the matching model in step 416. For example, in matching system 100, matching model results 308 may correspond to the resulting match or plurality of matches from the matching model 306. Server 108 may store the data in matching model results 308 into storage 110.

Process 300 continues by determining if a match has been determined between the first user and the second user in step 418. For example, in matching system 100, if the resulting match or plurality of matches included in matching model results 308 includes a match between the first user and the second user, server 100 can determine that a match has been determined. If matching system 100 cannot make the determination in step 418, process 300 ends in step 420. If matching system 100 determines that a match has been determined, process 300 continues to step 422.

Process 300 finishes by transmitting an indication to the first client device including information corresponding to the second user in step 422. For example, in matching system 100, server 108 may transmit the matching model results 308 to mentee client device 102 and mentor client device 104.

Process 300 may also make a matching determination using geographical information. For example, in matching system 100, server 108 may receive a first location indicator from mentee client device 102 and a second location indicator from mentor client device 104. Server 108 can determine a first geographical location corresponding to the first location indicator and determining a second geographical location corresponding to the second location indicator. Server 108 can transmit the second geographical location to the mentee client device 102 if the first geographical location is not equivalent to the second geographical location. Alternatively, if the first geographical location is the same as the second geographical location, the server 108 can transmit an indication to the mentee client device 102 that indicates that the mentor client device 104 is at the same geographical location.

Process 300 may also make a matching determination by determining a degree of relatedness between the first and second user. For example, in matching system 100, server 108 can determine the match by determining that the degree of relatedness is greater than or equal to a threshold limit.

Other objects, advantages and embodiments of the various aspects of the present invention will be apparent to those who are skilled in the field of the invention and are within the scope of the description and the accompanying Figures. For example, but without limitation, structural or functional elements might be rearranged consistent with the present invention. Similarly, principles according to the present invention could be applied to other examples, which, even if not specifically described here in detail, would nevertheless be within the scope of the present invention.

We Claim:

1. A system comprising:
a first client device configured to receive a first set of user input data from a first user;
a second client device configured to receive a second set of user input data from a second user;
a data store configured to store the first set of user input data and the second set of user input data;
one or more information sources communicatively coupled to a network; and
a server communicatively coupled to the first client device, the second client device, the data store, and the network, wherein the server is configured to:
receive the first set of user input data from the first client device and the second set of user input data from the second client device;
based on the received first set of user input data, search the one or more information sources for first secondary information associated with the first set of user input data;
based on the received second set of user input data, search the one or more information sources for second secondary information associated with the second set of user input data;
store the received first set of user input data, the received second set of user input data, the first secondary information, and second secondary information in the data store;
apply a matching model based on at least the received first set of user input data, the received second set of user input data, the first secondary information, and the second secondary information to determine a match between the first user and the second user; and
in response to determining the match between the first user and the second user, transmit an indication to the first client device including information corresponding to the second user.

2. The system of claim 1, wherein the first user is a mentee and the second user is a mentor.

3. The system of claim 1, wherein the first set of user input data comprises responses to a first set of queries presented to the first user by the first client device.

4. The system of claim 1, wherein the first client device comprises a user interface, wherein the user interface is configured to receive the first set of user input data.

5. The system of claim 1, wherein the server receives a first location indicator from the first client device.

6. The system of claim 5, wherein the server receives a second location indicator from the second client device. The system of claim 6, wherein the server is further configured to:
determine a first geographical location corresponding to the first location indicator;
determine a second geographical location corresponding to the second location indicator; and
in response to determining that the first geographical location is not equivalent to the second geographical location, transmit the second geographical location to the first client device.

8. The system of claim 5, wherein the first set of user input data includes the first location indicator.

9. The system of claim 8, wherein the second set of user input data includes the second location indicator.

10. The system of claim 5, wherein the server receives the first location indicator in response to sending a first query to the first client device.

11. The system of claim 10, wherein the server receives the second location indicator in response to sending a second query to the second client device.

12. The system of claim 1, wherein the server receives identifier information from at least one of the first client device and the second client device.

13. The system of claim 1, wherein the matching model includes at least one of graph theory based algorithm, blossom algorithm, Hungarian matching algorithm, Hoperoft-Karp algorithm, Gale-Shaply algorithm, stable matching problem algorithm, Nash equilibrium algorithm, rainbow algorithm, Irving's algorithm, multi-criteria index matching algorithm, gradient boosted decision trees (GBDT) algorithm, and Match-pairing algorithm.

14. The system of claim 1, wherein determining the match comprises determining a degree of relatedness between the first and second user.

15. The system of claim 14, wherein determining the match comprises determining that the degree of relatedness is greater than or equal to a threshold limit.

16. A method for matching users comprising:
receiving, at a first client device, a first set of user input data from a first user;
receiving, at a second client device, a second set of user input data from a second user;
storing, at a data store, the first set of user input data and the second set of user input data;
communicatively coupling a server to the first client device, the second client device, the data store, and a network, the network being communicatively coupled to one or more information sources; and
at the server:
receiving the first set of user input data from the first client device and the second set of user input data from the second client device;
based on the received first set of user input data, searching the one or more information sources for first secondary information associated with the first set of user input data;
based on the received second set of user input data, searching the one or more information sources for second secondary information associated with the second set of user input data;
storing the received first set of user input data, the received second set of user input data, the first secondary information, and second secondary information in the data store;
applying a matching model based on at least the received first set of user input data, the received second set of user input data, the first secondary information, and the second secondary information to determine a match between the first user and the second user; and
in response to determining the match between the first user and the second user, transmitting an indication to the first client device including information corresponding to the second user.

17. The method of claim 16, wherein the first set of user input data comprises responses to a first set of queries presented to the first user by the first client device.

18. The method of claim 16, further comprising:
receiving a first location indicator from the first client device;
receiving a second location indicator from the second client device;
determining a first geographical location corresponding to the first location indicator;
determining a second geographical location corresponding to the second location indicator; and
in response to determining that the first geographical location is not equivalent to the second geographical location, transmitting the second geographical location to the first client device.

19. The method of claim 16, wherein determining the match comprises determining a degree of relatedness between the first and second user.

20. The method of claim 19, wherein determining the match comprises determining that the degree of relatedness is greater than or equal to a threshold limit.
